(19) United States
(12) Patent Application Publication
(10) Pub. No.: US 2011/0199700 A1
(43) Pub. Date: Aug. 18, 2011

(54) PROCESS FOR PRODUCING MAGNETIC RECORDING MEDIUM AND MAGNETIC RECORDING AND REPRODUCING DEVICE

(75) Inventors: Katsumasa Hirose, Ichihara-shi (JP); Akira Sakawaki, Ichihara-Shi (JP); Masato Fukushima, Ichihara-Shi (JP)

(73) Assignee: SHOWA DENKO K.K., Minato-ku, Tokyo (JP)

(21) Appl. No.: 12/375,497

(22) PCT Filed: Jul. 30, 2007
(86) PCT No.: PCT/JP2007/064863

§ 371 Date: Apr. 5, 2010

(30) Foreign Application Priority Data
Aug. 1, 2006 (JP) 2006-209643

(51) Int. Cl. G11B 5/02; B05D 5/12

(52) U.S. Cl. 360/55; 427/129; G9B/5.026

(57) ABSTRACT

A process for producing a magnetic recording medium which can increase significantly yield and productivity is provided. Such a process for producing a magnetic recording medium includes a resist layer forming step which includes an immersing step of immersing a part of a non-magnetic substrate 31 in a resist solution 11 so that an inner circular domain 3 of an opening part is arranged above a liquid surface 11a of the resist solution 11 and a part of a data recording domain 4 is arranged under the liquid surface 11a of the resist solution 11, and a taking out step of taking the non-magnetic substrate 31 out from the resist solution 11, while rotating the non-magnetic substrate 31 immersed in the resist solution 11 around a rotation axis 37a extending in the direction of the thickness of the non-magnetic substrate 31 through the center of an opening part 37.

### BACKGROUND OF THE INVENTION

1. Field of the Invention

The present invention relates to a process for producing magnetic recording media which is used by HDDs, and a magnetic recorder and reproducing device.

Priority is claimed on Japanese Patent Application No. 2006-209643, filed Aug. 1, 2006, the content of which is incorporated herein by reference.

2. Description of Related Art

Recently, coverage of magnetic recorders such as magnetic disk devices, has increased significantly, and as the importance thereof increases, remarkable improvement of the recording density has been planned with respect to magnetic storage media used in these devices.

In particular, since MR head and PRML technology have been introduced, a rise of facial recording density has become further significant, GMR head, TMR head have been further introduced recently, and the facial recording density continues to increase at a pace of approximately 100% per year.

These magnetic recording media are required to increase recording density further in the future, and to increase coercive force, SN ratio (SNR), and resolving power of a magnetic recording layer.

In addition, in recent years, an effort of increasing facial recording density by increasing truck density has been continued, together with increasing of linear recording density.

In the latest magnetic recorder, truck density has reached 110 kTPI. However, if truck density increases, then magnetic recording information between adjacent trucks interferes with each other, and a magnetization transition region of the boundary region serves as a noise source to cause deterioration of SNR. This directly leads to deterioration of Bit Error Rate, and hence it serves as an obstacle to increase recording density.

It is necessary to downsize further the size of each recording bit on a magnetic recording medium so as to secure saturation magnetization and magnetic film thickness as large as possible, in order to increase facial recording density.

However, if recording bit is downsized, then the magnetization smallest volume per bit becomes small, and a problem that recorded data will be lost by magnetization turning due to a heat fluctuation.

In addition, if truck density increases, then the distance between trucks will decrease, and hence a magnetic recorder uses extremely highly accurate truck-servo technology and a method of making reproduction head width smaller than recording head width is generally used in order to remove influence from an adjacent truck as large as possible.

In this approach, influence between trucks can be suppressed at the minimum, however, it is difficult to produce sufficient reproduction output, and hence there can be a problem that it is difficult to secure SNR sufficiently.

As an approach to solve the problem of such a heat fluctuation, to secure SNR or sufficient output, it has been attempted to increase truck density by forming unevenness along a truck on the recording medium surface so as to separate physically recording trucks from each other.

Such a technology will be referred to as discrete truck method, and a recording medium which is produced thereby will be referred to as discrete truck medium, below.

As an example of a discrete truck medium, a magnetic recording medium which is produced by forming a magnetic recording medium onto a non-magnetic substrate having an uneven pattern surface so as to be constituted from physically separated magnetic recording trucks and servo signal patterns is known (for example, Patent Document 1).

The magnetic recording medium disclosed in Patent Document 1 has a soft magnetic layer having plurality of projected portions and recesses on a non-magnetic substrate, and a ferromagnetic layer formed on the soft magnetic layer.

In this magnetic recording medium, a perpendicular magnetic recording domain which is physically separated from surroundings in the projected domain is formed. In this magnetic recording medium, it is possible to suppress generation of the magnetic domain wall in the soft magnetic layer, thus the influence of heat fluctuation is hardly generate, and there is no interference between adjacent signals, and hence a high density magnetic recording medium having few noise can be formed.

In addition, the discrete truck method includes a method of forming tucks after magnetic recording medium consisting of plurality of thin films formed, and a method of forming thin films of magnetic recording medium previously and directly onto the substrate surface or after an uneven pattern is formed onto a thin film layer for forming trucks (for example, refer to Patent Document 2 and Patent Document 3).

Of these, the former method is often called a magnetic layer processing-type, which has a weak point that the medium is easily polluted in the production process and the production process is very complicated because physical processing to the surface is performed after the medium is formed.

On the other hand, the latter is often called an embossing type, which is hardly polluted during the production process, however the uneven shape which is formed onto the substrate will be transferred to film upon being formed, and hence there was a problem that floating posture and floating height of the recording and reproducing head which performs recording and reproducing while floating above the medium cannot be stabilized.

In addition, a method of forming a domain between magnetic trucks of a discrete truck medium by implanting nitrogen ions or oxygen ions into the magnetic layer previous formed or by irradiating a laser thereon has been disclosed (refer to Patent Document 4).

Moreover, formation of a magnetic recording pattern by ion irradiation through etching or converting a magnetic layer into amorphous in the production of a so-called patterned media in which the magnetic recording pattern is arranged per bit with a specific regularity has been disclosed (refer to Non-patent Document 1 and Patent Document 5)

In such discrete truck media or patterned media, a method which includes forming a magnetic layer on a substrate, and thereafter applying a resist to the surface, patterning the resultant resist using photolithography technology, and patterning the magnetic layer using the resist pattern has been adopted.

A spin coat method has been suggested as a method for applying a liquid material to magnetic recording disks (for example, see Patent Document 6).

[Patent Document 1]

Japanese Unexamined Patent Application, First Publication No. 2004-164692

[Patent Document 2]

Japanese Unexamined Patent Application, First Publication No. 2004-178793

[Patent Document 3]

Japanese Unexamined Patent Application, First Publication No. 2004-178794

[Patent Document 4]

Japanese Unexamined Patent Application, First Publication No. 5-205257

[Patent Document 5]

U.S. Pat. No. 6,331,364

[Patent Document 6]

Japanese Unexamined Patent Application, First Publication No. 2004-306032

[Non-patent Document 1]

SHINGAKU-GIHOU, The Institute of Electronics, Information and Communication Engineers, IEICE Technical Report MR2005-55(2006-02), page 21-page 26

However, in the case in which a liquid material is applied to a magnetic recording disk using the coating method disclosed in Patent Document 6, it has been a problem that coating irregularity easily occurs.

Since coating irregularity has a bad influence on the later process, it becomes a factor to deteriorate yield.

It is an object of the present invention to provide a process for producing a magnetic recording medium which can be suitably used for production of a discrete truck medium or a patterned medium, and which can increase significantly yield productivity. In addition, it is another object of the present invention to provide a magnetic recorder and reproducing device having a magnetic recording medium produced by the process for producing a magnetic recording medium of the present invention.

### SUMMARY OF THE INVENTION

In order to solve the problems, inventors of the present invention have thoroughly researched, and as a result, they have found that in the case in which a substrate having an opening part at the center is immersed in a resist solution and rotated so as to apply resist to whole of surface of the substrate, coating irregularity easily occurs even if the substrate is rotated, because the resist solution applied to periphery of the opening is hardly scattered, thereby completing the present invention.

In other words, the present invention provides the following inventions.
(1) A process for producing a magnetic recording medium including: a magnetic layer forming step of forming a magnetic layer which serves as a magnetic recording pattern onto a disc-like non-magnetic substrate having an opening part at the center, a troidal data recording domain, an inner circular domain located between the data recording domain and the opening part, a resist layer forming step of forming a resist layer on the non-magnetic substrate on which the magnetic layer is formed, and a pattern forming step of forming the magnetic recording pattern using the resist layer, in which the resist layer forming step comprises an immersing step of immersing a part of the non-magnetic substrate in the resist solution so that at least the periphery of the opening part is arranged above the liquid surface of the resist solution and a part of the data recording domain is arranged under the liquid surface of the resist solution, and a step of taking out step of taking the non-magnetic substrate out from the resist solution, while rotating the non-magnetic substrate immersed in the resist solution around a rotation axis extending in the direction of the thickness of the non-magnetic substrate through the center of an opening part.
(2) The process for producing a magnetic recording medium as set forth in (1), in which the immersing step is a step of immersing a part of the non-magnetic substrate in the resist solution, while rotating the non-magnetic substrate around the rotation axis.
(3) The process for producing a magnetic recording medium as set forth in (1) or (2), in which the rotation of the non-magnetic substrate around the rotation axis is performed continuously after the non-magnetic substrate is taken out from the resist solution.
(4) The process for producing a magnetic recording medium as set forth in (3), in which the rotation of the non-magnetic substrate around the rotation axis after the non-magnetic substrate is taken out from the resist solution is performed at a rotation rate higher than that of during the non-magnetic substrate is immersed in the resist solution.
(5) The process for producing a magnetic recording medium as set forth in (3) or (4), in which the rotation of the non-magnetic substrate during the non-magnetic substrate is immersed in the resist solution is performed at a rotation rate ranging from 350 to 500 rpm, and the rotation of the non-magnetic substrate after the non-magnetic substrate is taken out from the resist solution is performed at a rotation rate ranging from 5000 to 6000 rpm.
(6) The process for producing a magnetic recording medium as set forth in any one of (1) to (5), in which the non-magnetic substrate has a diameter ranging from 15 mm to 100 mm, and the distance between the data recording domain and the opening part in the direction of the diameter of the non-magnetic substrate ranges from 2 mm to 3 mm.
(7) The process for producing a magnetic recording medium as set forth in any one of (1) to (6), in which the resist layer forming step is a step of arranging a plurality of non-magnetic substrates in the direction of the thickness of the non-magnetic substrate.
(8) The process for producing magnetic recording medium as set forth in (7), in which the plurality of non-magnetic substrates has a distance of not less than 12 mm therebetween.
(9) A magnetic recorder and reproducing device, comprising: a magnetic recording medium, a driving part which drives the magnetic recording medium in the direction of recording, a magnetic head having a recording part and a reproducing part, a means for moving the magnetic head relative to the magnetic recording medium, and a recording and reproducing signal treating means for inputting a signal into the magnetic head and reproducing an output signal from the magnetic head, in which the magnetic recording medium is one produced by the process for producing a magnetic recording medium as set forth in any one of (1) to (8).

### EFFECT OF THE INVENTION

In accordance with the process for producing a magnet recording medium of the present invention, the resist layer forming step has an immersing step of immersing a part of the non-magnetic substrate in the resist solution so that at least the periphery of the opening part is arranged above the liquid surface of the resist solution and a part of the data recording domain is arranged under the liquid surface of the resist solution, and a step of taking out the non-magnetic substrate out from the resist solution, while rotating the non-magnetic substrate immersed in the resist solution around a rotation axis extending in the direction of the thickness of the non-magnetic substrate through the center of the opening part. And hence coating irregularity hardly occurs and it is possible to form a magnetic recording pattern with high accuracy by using the resultant resist layer. Therefore, in accordance with the process for producing a magnetic recording medium of the present invention, a magnetic recording medium which can provide high recording and reproducing characteristics such as a discrete truck medium or a patterned medium can be produced at a high yield.

Moreover, the recorder and reproducing device of the present invention is equipped with the magnetic recording medium produced by the process for producing a magnetic recording medium of the present invention, and hence it will be one which can provide high recording and reproducing characteristics.

### BRIEF DESCRIPTION OF THE DRAWINGS

FIG. 1 is a sectional view that shows an example of magnetic recording medium produced by the process for producing of the present invention.

FIG. 2 is a plane view that shows an example of a non-magnetic substrate 31 used for magnetic recording media shown in FIG. 1.

FIG. 3A is a figure for explaining an example of an immersing step of a resist layer forming step.

FIG. 3B is a figure for explaining an example of an immersing steps of a resist layer forming step.

FIG. 4 is a schematic view for explaining an example of a magnetic recording and reproducing device of the present invention.

[Explanation of Reference]

2 outer circular domain,

3 inner circular domain,

4 data recording domain,

11 resist solution,

11a liquid surface,

21 driving part,

27 magnetic head,

28 head driving part,

29 recording and reproducing signal treating means,

30 magnetic recording medium,

31 non-magnetic substrate,

32a soft magnetic layer,

32b intermediate layer,

33 magnetic recording pattern,

33a magnetic recording layer,

34 non-magnetic layer,

35 protective film,

36 lubrication layer,

37 opening part,

37a rotation axis,

38 periphery,

### DETAILED DESCRIPTION OF THE INVENTION

“The first embodiment”

An explanation will be given with respect to embodiments of the present invention below, while referring to drawings. However, the scope of the present invention is not limited to the following embodiments.

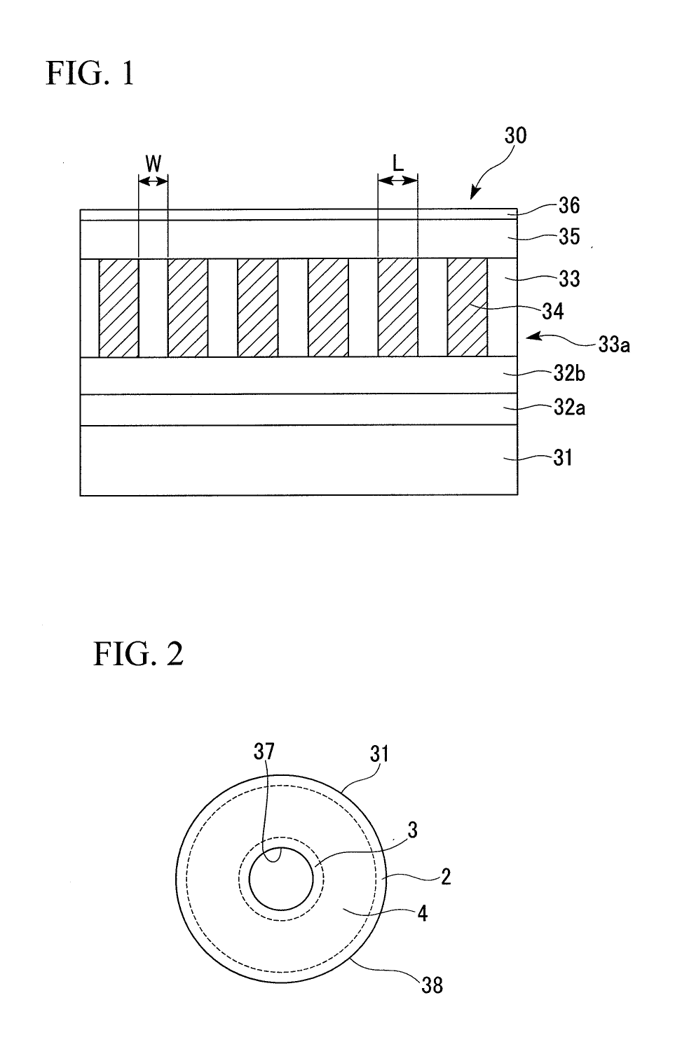

FIG. 1 is a sectional view which shows an example of a magnetic recording medium produced by the process for producing of the present invention typically. In this embodiment, an explanation will be given, referring to a magnetic recording medium of a discrete truck-type of which recording trucks are magnetically discontinuously arranged.

A magnetic recording medium 30 shown in FIG. 1 is read and written using a magnetic head. The magnetic recording medium 30 is constituted from a non-magnetic substrate 31, a soft-magnetic layer 32a, an intermediate layer 32b, a magnetic recording layer 33a consisting of a magnetic recording pattern 33 made of a magnetic layer and a non-magnetized layer 34 arranged alternately, a protective film layer 35, and a lubrication layer 36 formed successively onto the surface of the non-magnetic substrate 31.

As the non-magnetic substrate 31 used in this embodiment, for example, the non-magnetic substrate 31 shown in FIG. 2 is used. FIG. 2 is a plane view that shows an example of the non-magnetic substrate 31 used in the magnetic recording medium shown in FIG. 1.

The non-magnetic substrate 31 shown in FIG. 2 is a disc-like one having a circular opening part 37 perforated at the center thereof, and as shown in FIG. 2, the non-magnetic substrate 31 has a data recording domain 4 having a shape like a ring which is a concentric circle of the opening part 37, an inner circular domain 3 located between the data recording domain 4 and the opening part 37, and an outer circular domain 2 located between the data recording domain 4 and a periphery 38.

The inner circular domain 3 is a domain which is used when the magnetic recording medium is attached to a spindle of a motor.

The outer circular domain 2 is a certain domain in the case in which it is impossible to read and write using a magnetic head, for example, a certain domain having a distance between the periphery 38 and the data recording domain 4 in the direction of the diameter of the non-magnetic substrate 31 which is approximately ½ of the width of the magnetic head.

In this embodiment, for example, a non-magnetic substrate having a diameter ranging from 15 mm to 100 mm, and a distance between the data recording domain 4 and the opening part 37 in the direction of the diameter of the non-magnetic substrate 31 (width of the inner circular domain 3) ranging from 2 mm to 3 mm is preferably used.

As a material for the non-magnetic substrate 31, an arbitrary material of a non-magnetic material, for example, an Al alloy substrate consisting mainly of Al, such as Al—Mg alloys, ordinal soda-lime glass, aluminosilicate-type glass, crystallized glass, silicon, titanium, ceramics, and various resin can be used. In these, it is preferable to use a glass substrate such as an Al alloy substrate or crystallized glass or a silicon substrate.

In addition, average surface roughness of the non-magnetic substrate 31 is preferably not more than 1 nm, more preferably not more than 0.5 nm, and the most preferably not more than 0.1 nm.

In this embodiment, each of FeCoB layer as a soft magnetic layer 32a and Ru layer as an intermediate layer 32b is formed onto the surface of the non-magnetic substrate 31.

In addition, in this embodiment, although the magnetic recording layer 33a may be either an in-plane magnetic recording layer, or a vertical magnetic recording layer, preferably the magnetic layer 33a is a vertical magnetic recording layer so as to attain higher recording density. It should be noted that it is preferable to form these magnetic recording layers from an alloy which consists mainly of Co.

As a magnetic-recording layer for use in an in-plane magnetic recording medium, for example, a laminate structure consisting of a non-magnetic CrMo ground layer and a ferromagnetic CoCrPtTa magnetic layer can be used.

In addition, as a magnetic recording layer for use in a vertical magnetic recording medium, for example, those produced by laminating a backing layer consisting of an FeCo alloy such as FeCoB, FeCoSiB, FeCoZr, FeCoZrB, FeCoZrBCu, etc., an FeTa alloy such as FeTaN, FeTaC, etc.,and a Co alloy such as CoTh7r, CoZrNB, CoB, etc.; an orientation control film such as Pt, Pd, NiCr, NiFeCr, etc.; if necessary an intermediate film such as Ru, etc.; and a magnetic layer consisting of 60Co-15Cr-15Pt alloy or 70Co-5Cr-15Pt-10SiO₂ alloy can be utilized.

The magnetic recording layer 33a may be formed so as to acquire a sufficient head output and input, corresponding to the kind and layered structure of a magnetic alloy to be used.

Thickness of the magnetic recording layer 33a is preferably not less than 3 nm and not more than 20 nm, more preferably not less than 5 nm and not more than 15 nm. The magnetic recording layer 33a necessitates a thickness of not less than a certain level in order to acquire an output of not less than a predetermined value when reproducing. On the other hand, because some parameters indicating recording and reproducing characteristics usually deteriorate as output increases, it is necessary to set film thickness of the magnetic recording layer 33a to be optimum.

In addition, in order to increase recording density, as shown in FIG. 1, the magnetic part width W of the magnetic recording pattern 33 is preferably not more than 200 nm, and the non-magnetic part width L of the non-magnetized layer 34 is preferably not more than 100 nm. The truck pitch P (=W+L) is preferably not more than 300 nm, and is preferable to be as small as possible in order to increase recording density.

In addition, as protective film 35, materials ordinarily used as a material of protective films, e.g. carbonaceous layer such as carbon (C), hydrogenated carbon (H×C), carbon nitride(LCN), amorphous carbon, silicon carbide(SiC), etc., or SiO₂, Zr₂O₃, TiN, etc. can be used. In addition, the protective film 35 may be either a single layer or constituted from two or more layers.

The thickness of the protective film 35 is preferably less than 10 nm. If thickness of protective film 35 is more than 10 nm, then when a magnetic recorder and reproducing device is produced using such a magnetic recording medium, the distance between the magnetic head and the magnetic recording pattern 33 will be large, and sufficiently intensity of output and input signal may not be obtained.

As a lubricant used for the lubrication layer 36, a fluorine type lubricant, a hydrocarbon type lubricant and mixtures thereof are exemplary. The distance Lubrication layer 36 is usually formed at a thickness ranging from 1 to 4 nm. It should be noted that, onto the protective film 35, the lubrication layer 36 is preferably formed, however, the lubrication layer may not be formed.

Next, an explanation will be given below, with respect to an example of the process for producing a magnetic recording medium shown in FIG. 1.

In the production of the magnetic recording medium shown in FIG. 1, at first, onto the data recording domain 4 of the non-magnetic substrate 31 shown in FIG. 2, magnetic layers each of which will serve as a soft magnetic layer 32a, an intermediate layer 32b, and a magnetic recording layer 33a are formed sequentially, using a sputtering method (magnetic layer forming step).

Subsequently, the protective film 35 is formed on the surface of the magnetic layer which will serve as the magnetic recording layer 33a, using a sputtering method or CVD method.

Thereafter, as shown below, the magnetic layer which will serve as the magnetic recording layer 33a is made to be the magnetic recording pattern 33 and non-magnetized layer 34 which are magnetically isolated from each other, using photolithography technology.

At first, a resist layer is formed on the surface of the protective film 35 (resist layer forming step).

In the resist layer forming step, at first, a non-magnetic substrate 31 is installed to a coating apparatus which is equipped with a spindle part which is rotated by a driving apparatus.

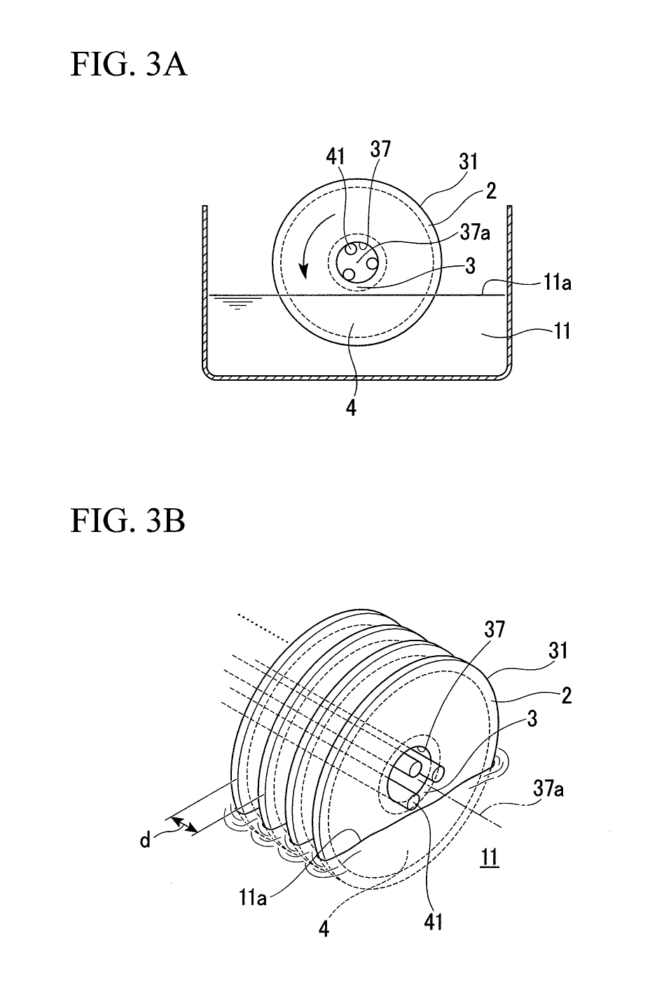

In the installing (chucking) of the non-magnetic substrate 31 to the spindle part, as shown in FIG. 3A, three pieces of a rod-like member which constitute a chuck 41 of the spindle part are penetrated through the opening part 37 of the non-magnetic substrate 31, and the three pieces of the rod-like member are extended from the center outwardly, thereby making the three pieces of the rod-like member support the inside end of the opening 37 of the non-magnetic substrate 31 to fix the non-magnetic substrate 31.

Subsequently, as shown in FIG. 3A, a part of the non-magnetic substrate 31 is immersed in a resist solution 11, such that an inner circular domain 3 of the non-magnetic substrate 31 is arranged above the liquid surface 11a of the resist solution 11, and a part of the data recording domain 4 of the non-magnetic substrate 31 is arranged under the liquid surface 11a of the resist solution 11(immersing step).

The resist solution 11 is not limited particularly, however, for example, a solution which consists of an organic application glass (SOG) and has a viscosity ranging from 0.1 cP to 10 cP(1P=0.1Pa.s) is preferable.

Preferably, the immersion of the non-magnetic substrate 31 into the resist solution 11 is perfoimed, while rotating the non-magnetic substrate 31 around the rotation axis 37a extending in the direction of thickness of the non-magnetic substrate 31 through the center of the opening part 37 of the non-magnetic substrate 31. Rotation of the non-magnetic substrate 31 is performed by rotating a spindle part of a driving device of coating apparatus.

For example, in the case in which the non-magnetic substrate 31 is rotated after the non-magnetic substrate 31 is immersed in the resist solution 11, there is a possibility that the resist solution 11 may be scattered by an impact generated when the rotation of the non-magnetic substrate 31 is started, and adhered to the inner circular domain 3 of the non-magnetic substrate 31.

In addition, in the beginning of rotating the non-magnetic substrate 31, the number of revolution is low and centrifugal force is small, thereby the resist solution 11 applied to the non-magnetic substrate 31 may drip downwardly due to gravity, and hence there is a possibility that the resist solution 11 may be adhered to the inner circular domain 3 of the non-magnetic substrate 31.

In respond to this, it is possible to prevent the resist solution 11 from adhering to the inner circular domain 3 of the non-magnetic substrate 31, by immersing the non-magnetic substrate 31 into the resist solution 11, while rotating the non-magnetic substrate 31.

Thereafter, the non-magnetic substrate 31 immersed in the resist solution 11 is taken out from the resist solution 11, while continuing to rotate the non-magnetic substrate 31 around the rotation axis 37a (taking out step).

Even more particularly, in the present embodiment, rotation of the non-magnetic substrate 31 is kept on rotating around the rotation axis 37a is continued after the non-magnetic substrate 31 from the resist solution 11.

Thus, it is possible to apply the resist solution 11 to the data recording domain 4 having a more uniform thickness, without adhering the resist solution 11 to the inner circular domain 3 of the non-magnetic substrate 31. The resist solution 11 can be applied to data recording domain 4 in uniform film thickness without making resist solution 11 adhere to inner circular domain 3 of the non-magnetic substrate 31.

The rotation rate of the non-magnetic substrate 31 is preferably increased after the non-magnetic substrate 31 is taken out from the resist solution 11 so as to be higher than that when the non-magnetic substrate 31 is immersed in the resist solution 11.

The rotation rate of the non-magnetic substrate 31 during immersing the non-magnetic substrate 31 in the resist solution 11 is determined so as to obtain centrifugal force which can prevent the applied resist solution 11 from dripping downward by gravity to adhere to the inner circular domain 3 of the non-magnetic substrate 31.

If the rotation rate (number of revolutions) during immersing the non-magnetic substrate 31 in the resist solution 11 is increased excessively, then adhering of the resist solution 11 to the non-magnetic substrate 31 is inhibited, and the liquid surface of the resist solution 11 is shaken to promote the resist solution 11 to adhere to the inner circular domain 3 of the non-magnetic substrate 31. Specifically, the rotation rate during immersing the non-magnetic substrate 31 in the resist solution 11 preferably ranges from 350 rpm to 500 rpm, which can be suitably determined based on the viscosity of the resist solution 11 or size of the non-magnetic substrate 31.

Moreover, the rotation rate which is increased after the non-magnetic substrate 31 is taken out from the resist solution 11 is determined so as to obtain a centrifugal force which can scatter unnecessary resist solution 11, in addition to prevent the applied resist solution 11 from dripping downward by gravity to adhere to the inner circular domain 3 of the non-magnetic substrate 31.

In addition, if the rotation rate which is increased after the non-magnetic substrate 31 is taken out from the resist solution 11 is increased excessively, then the thickness of the resist will be thin remarkably due to shaking off of the resist, and uniformity of thickness will deteriorate.

Specifically, the rotation rate which is increased after the non-magnetic substrate 31 is taken out from the resist solution 11 preferably ranges from 5000 rpm to 6000 rpm, which can be suitably determined based on the viscosity of the resist solution 11 or size of the non-magnetic substrate 31.

In addition, in the case in which a non-magnetic substrate 31 having a diameter ranging from 15 mm to 100 mm and a distance (width of inner circular domain 3) in the direction of diameter of non-magnetic substrate 31 between the data recording domain 4 and the opening part 37 ranging from 2 mm to 3 mm, and a resist solution 11 having a viscosity, e.g. a general value ranging from 0.1 cP to 10 cP, is used, the rotation rate during immersing the non-magnetic substrate 31 in the resist solution 11 is set within the range of 350 rpm to 500 rpm, and the rotation rate is increased to a range from 5000 rpm to 6000 rpm after the non-magnetic substrate 31 is taken from the resist solution 11, it is possible to prevent certainly the resist solution from adhering to the inner circular domain 3 of the non-magnetic substrate 31, and to apply the resist solution 11 to the data recording domain 4 at a uniform thickness.

Next, using the resist layer applied in this way, a magnetic recording pattern is formed (pattern forming step). Specifically, a resist layer is patterned using photolithography technology, thereby partially reducing the thickness of the resist layer, or removing the resist layer partially.

Subsequently, atoms are irradiated from the surface side of the resist layer. By this operation, an atom is implanted partially into the part of the magnetic layer having a thin resist layer or no resist layer to form a non-magnetized layer 34, and simultaneously, the magnetic recording pattern 33 consisting of a magnetic layer in which no atoms have been implanted is formed onto a part where the resist layer is present, thereby forming the magnetic recording layer 34 in which each of the magnetic recording pattern 33 and the non-magnetized layer 34 is arranged alternately.

As the atoms to be implanted into magnetic layer, for example, B, F, Si, P, Ar, Kr, In, Xe are exemplary.

By implanting atoms into magnetic layer at this step, the crystal structure of the magnetic layer becomes amorphous, and the magnetic layer becomes non-magnetic. Thereafter, all of the resist layer removed, the lubrication layer 36 is formed on the protective film 35 to form the magnetic recording medium 30 shown in FIG. 1.

In this embodiment, the data recording domain 4 of the non-magnetic substrate 31 is immersed in the resist solution 11 in the immersing step of the resist layer forming step, however, the inner circular domain 3 is not immersed into the resist solution 11. Thus, the resist solution 11 is prevented from coming into contact with the inner circular domain 3, thereby preventing the resist solution 11 from coming into contact with the periphery of the opening part 37.

In addition, in this embodiment, in the taking out step of the resist layer forming step, the non-magnetic substrate 31 is taken out from the resist solution 11, while rotating the non-magnetic substrate 31 immersed in the resist solution 11 around a rotation axis 37a, and hence it is possible to scatter by centrifugal force unnecessary resist solution 11 adhered to the non-magnetic substrate 31, and to apply the resist solution 11 to the non-magnetic substrate 31 uniformly.

Thus, in accordance with the process for producing a magnetic recording medium, it is possible to form a magnetic recording pattern accurately, using the resultant resist layer, and to produce a discrete truck-type magnetic recording medium which can provide excellent recording and reproducing characteristics, at a high yield.

In contrast, for example, in the case in which the resist solution 11 is applied to the periphery of the opening part 37, even if the non-magnetic substrate 31 is rotated around the rotation axis 37a after applying the resist solution 11, the centrifugal force which generates at the periphery of the opening part 37 is small, and hence the resist solution 11 applied to the periphery of the opening part 37 is hardly scattered.

And as a result, in the case in which the resist solution 11 is applied to the periphery of the opening part 37, coating irregularity easily occurs.

The resist layer is finally removed in the production process of magnetic recording medium, however, a coating irregularity of the resist solution 11 in the producing step before the removal of resist layer is a factor to cause bad influence in the shape of a magnetic recording pattern, and coating irregularity of the resist solution 11 deteriorates production yield of the magnetic recording medium.

It should be noted that in this embodiment the non-magnetic substrate 31 is immersed in the resist layer 11 such that the inner circular domain 3 of the non-magnetic substrate 31 is arranged above the liquid surface 11a of the resist solution 11, however, it is not always necessary to arrange all of the inner circular domain 3 of the non-magnetic substrate 31 above the liquid surface 11a of the resist solution 11, at least the periphery of the opening part 37 should be arranged above the liquid surface 11a of the resist solution 11. “

The second embodiment”

Although in the process for producing in the above first embodiment, an explanation was given referring to the case of forming a resist layer onto one non-magnetic substrate, as shown in FIG. 3B, a resist layer may be formed onto a plurality of non-magnetic substrates at a time. FIG. 3B is a drawing for explaining other examples of the immersing step of the resist layer forming step, and a schematic perspective view which shows only the non-magnetic substrate 31 and the resist solution 11. In the process for producing a magnetic recording medium of this embodiment, what is different from the first embodiment is only the number of the non-magnetic substrates 31 onto which the resist solution is applied in the resist layer forming step, and hence explanations of the other is omitted.

In the process for producing a magnetic recording medium in this embodiment, each of four pieces of the non-magnetic substrate 31 is arranged in the direction of the thickness of the non-magnetic substrate 31, apart from each other. A distance d between each of four pieces of the non-magnetic substrates 31 shown in FIG. 3B can be suitably determined by the size of the non-magnetic substrate 31, for example, “d” is preferably not less than 17 mm in the case in which diameter of the non-magnetic substrate 31 is 1.89 (φ48 mm), and for example, “d” is preferably not less than 4 mm in the case in which the diameter of the non-magnetic substrate 31 is 0.85 (φ21 mm).

If the distance “d” between the plurality of non-magnetic substrates 31 is small, then fluidity of the resist solution between the non-magnetic substrate 31 and non-magnetic substrate 31 becomes insufficient, and coating irregularity of the resist solution 11 may become large.

In the process for producing a magnetic recording medium of this embodiment, the non-magnetic substrate 31 is installed to the coating device, similar to the first embodiment.

In other words, as shown in FIG. 3B, in the installing (chucking) of the four pieces of the non-magnetic substrate 31 to the spindle part, three pieces of a rod-like member which constitute a chuck 41 of the spindle part are penetrated through the opening part 37 of the four pieces of the non-magnetic substrate 31, and the three pieces of the rod-like member are extended from the center outwardly, thereby making the three pieces of the rod-like member support the inside end of the opening 37 of the non-magnetic substrate 31 to fix the non-magnetic substrate 31.

In the process for producing a magnetic recording medium of this embodiment, similar to the first embodiment, in the resist forming step, a part of the non-magnetic substrate 31 is immersed in the resist solution 11, such that the inner circular domain 3 of the non-magnetic substrate 31 is arranged above the liquid surface 11a of the resist solution 11, and a part of the data recording domain 4 of the non-magnetic substrate 31 is arranged under the liquid surface 11a of the resist solution 11(immersing step), and thereafter, the non-magnetic substrate 31 immersed in the resist solution 11 is taken out from the resist solution 11, while continuing to rotate the non-magnetic substrate 31 around the rotation axis 37a (taking out step).

Thus, in this embodiment, the resist solution 11 is prevented from coming into contact with the inner circular domain 3, thereby preventing the resist solution 11 from coming into contact with the periphery of the opening part 37.

In addition, in this embodiment, unnecessary resist solution 11 adhered to the non-magnetic substrate 31 can be scattered by centrifugal force, and hence it is possible to apply the resist solution 11 to the non-magnetic substrate 31 uniformly.

Moreover, in the process for producing a magnetic recording medium in this embodiment, each of the plurality of non-magnetic substrates 31 is arranged apart from each other in the direction of the thickness of the non-magnetic substrate 31, and hence a process which excels in productivity is provided.

In addition, in the process for producing of this embodiment, it is possible to prevent coating irregularity in the case in which the plurality of non-magnetic substrates 31 is arranged, by adjusting the distance between one non-magnetic substrate 31 and another non-magnetic substrate 31 to be not less than 12 mm of the plurality of non-magnetic substrates 31.

Thus, in the process for producing a magnetic recording medium of this embodiment, it is possible to form a magnetic recording pattern accurately using the resultant resist layer, and to produce a discrete truck-type magnetic recording medium, which can provide excellent recording and reproducing characteristics, at a high yield.

It should be noted that, in the present invention, it is preferable to immerse the non-magnetic substrate 31 in the resist solution 11, while rotating the non-magnetic substrate 31, however, the non-magnetic substrate 31 may be rotated after the non-magnetic substrate 31 is immersed in the resist solution 11.

In addition, in the above embodiment, the resist layer forming step may be performed after the protective film 35 is formed and before the lubrication layer is formed, however, the resist layer forming step may be performed at any step as far as it is after the magnetic layer which serves as a magnetic layer is formed, for example, it may be formed either immediately after the magnetic layer which serves as a magnetic recording layer is formed, or after the lubrication layer is formed.

Moreover, in the example shown in FIG. 3B, an explanation was given referring to the case of forming a resist layer onto four pieces of non-magnetic substrate at a time, the number of pieces of the non-magnetic substrate may be any number, and is not particularly limited.

“Magnetic recorder and reproducing device”

Next, an explanation will be given with respect to the magnetic recorder and reproducing device of the present invention.

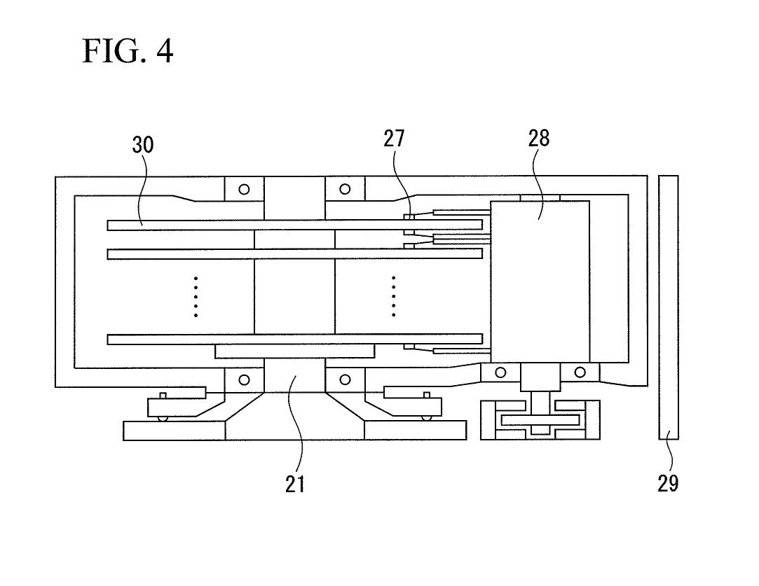

FIG. 4 is a schematic view for explaining an example of the magnetic recorder and reproducing device of the present invention.

The magnetic recorder and reproducing device shown in FIG. 4 is equipped with the magnetic recording medium 30, a driving part 21 which drives the magnetic recording medium in the direction of recording, a magnetic head 27 consisting of a recording part and a reproducing part, a head driving part 28 which relatively drives the magnetic head 27 to the magnetic recording medium 30, and a recording and reproducing signal treating means 29 for inputting signals into the magnetic head and reproducing signals output from the magnetic head 27. In the magnetic recorder and reproducing device shown in FIG. 4, as the magnetic recording medium 30, the magnetic recording medium shown in FIG. 1 produced by the process for producing a magnetic recording medium in the above is used.

The magnetic recorder and reproducing device shown in FIG. 4 is equipped with the discrete truck-type magnetic recording medium shown in FIG. 4 having excellent recording and reproducing characteristics, and hence which serves as a recording and reproducing device having a high recording density.

In addition, since the magnetic recorder and reproducing device shown in FIG. 4 is equipped with a magnetic recording medium on which recording trucks are arranged discontinuously, it is possible to operate even if the width of the reproducing head is made equivalent to that of the recording head, although hitherto the width of the reproducing head should be made smaller than the width of the recording head in order to avoid the influence of magnetization transition domain of the truck edge part. Thereby, it is possible to provide a sufficient reproducing output and a high SNR.

The present invention will be explained below by examples more in detail, however the scope of the present invention is not limited to only these examples.

### EXAMPLE

A non-magnetic substrate 31 shown in FIG. 2 which is made of crystallized glass consisting of Li₂Si₂O₅, Al₂O₃—K₂O, Al₂O₃—K₂O, MgO—P₂O₅, and Sb₂O₃—ZnO for use in a hard disc (HD) having a diameter of 1.89″ (φ48 mm) was prepared and arranged in a vacuum chamber of a sputtering apparatus, and thereafter the vacuum chamber was evacuated until the pressure became not more than 1.0×10⁻⁵ Pa.

Subsequently, onto the data recording domain 4 of the non-magnetic substrate 31, each of a soft magnetic layer 32a consisting of FeCoB, an intermediate layer 32b consisting of Ru, and a magnetic layer consisting of a 70Co-5Cr-15Pt-10SiO₂ alloy (magnetic layer forming step) was formed sequentially, using a sputtering method. Subsequently, onto the surface of the magnetic layer, each of a protective film 35 consisting of C (carbon) and a lubrication layer 36 consisting of a fluorine-type lubricant was formed sequentially, using a CVD method.

As for the thickness of each layer, soft magnetic layer was 600 Å, intermediate layer was 100 Å, magnetic layer was 150 Å, protective film was 4 nm, and lubrication layer was 2 nm, respectively.

Thereafter, a resist layer was formed on the surface of the lubrication layer 36 (resist layer forming step).

In the resist layer forming step, at first, an inner circular domain 3 of the non-magnetic substrate 31 was installed to a parallel spindle, the non-magnetic substrate 31 was arranged so that a liquid surface 11a of a resist solution 11 should come to a position under the inner circular domain 3 of the non-magnetic substrate 31 by 2 to 3 mm, and a part of the non-magnetic substrate 31 was immersed in the resist solution for 10 seconds, while rotating the non-magnetic substrate 31 around a rotation axis 37a at a rotation rate ranging from 350 rpm to 500 rpm (immersing step).

As the resist solution 11, an organic applied glass (SOG) having viscosity of 1 cP was used.

Thereafter, while continuing to rotate the non-magnetic substrate 31 around the rotation axis 37a at a rotation rate ranging from 350 rpm to 500 rpm, the non-magnetic substrate 31 immersed in the resist solution 11 was taken out from the resist solution 11(taking out step).

Moreover, after the non-magnetic substrate 31 was taken out from the resist solution 11, the rotation of the non-magnetic substrate 31 around the rotation axis 37a at a rotation rate ranging from 350 rpm to 500 rpm was continued for 15 seconds, and thereafter the rotation rate was increased to a range from 5000 rpm to 6000 rpm and then the rotation was continued for 12 seconds further.

Using the resist layer obtained by being applying and drying in this way, as shown below, a magnetic recording pattern was formed (pattern forming step).

That is, the resist layer is patterned using photolithography technology, thereby removing the resist layer partially.

Thereafter, Ar was irradiated as an atom from the surface of the resist layer, and an atom was implanted partially into the magnetic layer of the part of the magnetic layer without the resist layer 11 to form a non-magnetized layer 34, thereby forming a magnetic recording layer 33a in which each of the magnetic recording pattern 33 and the non-magnetized layer 34 was arranged alternately.

Thereafter, all of the resist layer removed to obtain a magnetic recording medium 30 shown in FIG. 1.

The magnetic recording medium 30 thus obtained was evaluated with respect to electromagnetic conversion characteristics, as shown below. And as a result, the magnetic recording and reproducing characteristics were observed in all of the magnetic recording bits. In the evaluation of the electromagnetic conversion characteristics, Read

Wright Analyzer 1632 produced by GUZIK Co., Ltd. in U.S.A. and a spin stand S1701MP were used.

As for a recording and reproducing head, a GMR head was used.

### Comparative Example

Onto the data recording domain 4 of the non-magnetic substrate 31 which is similar to the Example, each of a soft magnetic layer 32a, an intermediate layer 32b, a magnetic layer, a protective film 35, and a lubrication layer 36 were formed, by the same as in the Example.

Thereafter, the same resist solution as in the Example was applied to the whole of the non-magnetic substrate 31, by the method shown below.

A substrate was immersed in a resist solution up to a chucking position of an opening part of the substrate, thereby applying the resist to the substrate at 400 rpm for 10 seconds.

Thereafter, the substrate was taken out from the resist, and the substrate was rotated at 500 rpm for 12 seconds to shake the resist off.

After the resist was applied in this way, a magnetic recording pattern was formed similarly to the Example. Thereafter, all of the resist layer removed to obtain a magnetic recording medium 30 shown in FIG. 1.

The magnetic recording medium 30 thus obtained was evaluated with respect to electromagnetic conversion characteristics, by the same way as in the Example. And as a result, a lot of defects of the magnetic recording bits were observed at the truck in the vicinity of the inner circular domain 3 of the non-magnetic substrate 31. The cause of defects of these magnetic recording bits was unevenness in the film thickness of the resist solution applied to the vicinity of the inner circular domain 3 of the non-magnetic substrate 31, and hence the accuracy of developing of magnetic recording pattern in the photolithography became insufficient, thereby forming no magnetic recording pattern having a specific shape.

### Industrial Applicability

The present invention is applicable to a process for producing a magnetic recording medium for use in a hard disc drive apparatus and a magnetic recorder and reproducing device.

What is claimed is:

1. A process for producing a magnetic recording medium comprising: a magnetic layer forming step of forming a magnetic layer which serves as a magnetic recording pattern onto a disc-like non-magnetic substrate having an opening part at the center, a troidal data recording domain, inner circular domain located between the data recording domain and the opening part, a resist layer forming step of forming a resist layer on the non-magnetic substrate on which the magnetic layer is formed, and a pattern forming step of forming the magnetic recording pattern using the resist layer, wherein the resist layer forming step comprises an immersing step of immersing a part of the non-magnetic substrate in the resist solution so that at least a periphery of the opening part is arranged above a liquid surface of the resist solution and a part of the data recording domain is arranged under the liquid surface of the resist solution, and a taking out step of taking the non-magnetic substrate out from the resist solution, while rotating the non-magnetic substrate immersed in the resist solution around a rotation axis extending in the direction of the thickness of the non-magnetic substrate through the center of an opening part.

2. The process for producing a magnetic recording medium as set forth in claim 1, wherein the immersing step is a step of immersing a part of the non-magnetic substrate in the resist solution, while rotating the non-magnetic substrate around a rotation axis.

3. The process for producing a magnetic recording medium as set forth in claim 1 or 2, wherein the rotation of the non-magnetic substrate around the rotation axis is performed continuously after the non-magnetic substrate is taken out from the resist solution.

4. The process for producing a magnetic recording medium as set forth in claim 3, wherein the rotation of the non-magnetic substrate around the rotation axis after the non-magnetic substrate is taken out from the resist solution is performed at a rotation rate higher than that of during the non-magnetic substrate is immersed in the resist solution.

5. The process for producing a magnetic recording medium as set forth in claim 3, wherein the rotation of the non-magnetic substrate during the non-magnetic substrate is immersed in the resist solution is performed at a rotation rate ranging from 350 to 500 rpm, and the rotation of the non-magnetic substrate after the non-magnetic substrate is taken out from the resist solution is performed at a rotation rate ranging from 5000 to 6000 rpm.

6. The process for producing a magnetic recording medium as set forth in any one of claims 1 to 5, wherein the non-magnetic substrate has a diameter ranging from 15 mm to 100 mm, and distance between the data recording domain and the opening part in the direction of diameter of the non-magnetic substrate ranges from 2 mm to 3 mm.

7. The process for producing a magnetic recording medium as set forth in claim 1 or 2, wherein the resist layer forming step is a step of arranging a plurality of non-magnetic substrates in the direction of the thickness of the non-magnetic substrate.

8. The process for producing a magnetic recording medium as set forth in claim 7, wherein the plurality of non-magnetic substrates has a distance of not less than 12 mm therebetween.

9. A magnetic recorder and reproducing device, comprising: a magnetic recording medium, a driving part which drives the magnetic recording medium in the direction of recording, a magnetic head having a recording part and a reproducing part, a means for moving the magnetic head relative to the magnetic recording medium, and a recording and reproducing signal treating means for inputting a signal into the magnetic head and reproducing an output signal from the magnetic head, wherein the magnetic recording medium is one produced by the process for producing a magnetic recording medium as set forth in claim 1 or 2.
